(19) United States
(12) Patent Application Publication
(10) Pub. No.: US 2014/0032249 A1
(43) Pub. Date: Jan. 30, 2014

(54) INSURANCE ADJUSTMENT FOR CLOUD BASED SERVICES

(71) Applicant: Ezekiel Kruglick, Poway, CA (US)

(72) Inventor: Ezekiel Kruglick, Poway, CA (US)

(73) Assignee: Empire Technology Development LLC, Wilmingon (DE)

(21) Appl. No.: 14/004,132

(22) PCT Filed: May 22, 2012
(86) PCT No.: PCT/US12/38989

§ 371 Date: Sep. 9, 2013

(51) Int. Cl. G06Q 40/08

(52) U.S. Cl. CPC G06Q 40/08
USPC 705/4

(57) ABSTRACT

Technologies are generally described for an architecture and system for conducting insurance adjusting for cloud-related data or computing services. In some examples, the system may be configured to collect data regarding datacenter performance degradations, and may include an adjusting interface, a claim reporting interface, and connected infrastructure to collect instrumented data associated with cloud-related data/computing service performance. The collected data may be used for event classification and liability assignment so that insurance can be meaningfully written and processed.

### BACKGROUND

Unless otherwise indicated herein, the materials described in this section are not prior art to the claims in this application and are not admitted to be prior art by inclusion in this section.

Insurance products for the physical world are widespread, and may cover various types of business events, from explicit damages due to fires or theft to implied losses such as lost sales due to inventory delayed in shipping. However, insurance for data and computing processes or services are typically much more limited. Several forms of insurance coverage for specific events exist, but these typically only cover defined expenses, generally paid to a third party and payments are triggered by real-world events, such as lawsuits, criminal cases, or enforcement actions.

### SUMMARY

The present disclosure generally describes technologies related to insurance claim adjustment in cloud-based services based on datacenter performance degradations.

According to some examples, a method for providing insurance claim adjustment based on datacenter performance degradations may include monitoring operations of a datacenter, recording performance degradations associated with the datacenter operations, and adjusting one or more insurance claims based on the recorded performance degradations.

According to other examples, a server configured to perform insurance claim adjustment based on datacenter performance degradations may include a memory configured to store instructions and a processor configured to execute a monitoring application in conjunction with the stored instructions. The process may be further configured to monitor operations of a datacenter, record performance degradations associated with the datacenter operations, and adjust one or more insurance claims based on the recorded performance degradations.

According to further examples, a computer-readable memory device may have instructions stored thereon for providing insurance claim adjustment based on datacenter performance degradations. The instructions may include monitoring operations of a datacenter, recording performance degradations associated with the datacenter operations, and adjusting one or more insurance claims based on the recorded performance degradations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter, where insurance claim adjustment based on datacenter performance degradations may be provided;

FIG. 2 illustrates major components of a system for providing insurance claim adjustment in cloud-based services based on datacenter performance degradations;

FIG. 3 illustrates an overview of interactions between components of a system for providing insurance claim adjustment based on datacenter performance degradations;

FIG. 4 illustrates example configurations for monitoring datacenter operations in a cloud-based service;

FIG. 5 illustrates a general purpose computing device, which may be used to implement a system for providing insurance claim adjustment based on datacenter performance degradations;

FIG. 6 is a flow diagram illustrating an example method for providing insurance claim adjustment in cloud-based services based on datacenter performance degradations; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to insurance claim adjustment in cloud-based services based on datacenter performance degradations.

Briefly stated, technologies are presented for an architecture and system for conducting insurance adjusting for cloud-related data or computing services. The system may be configured to collect data regarding datacenter performance degradations, and may include an adjusting interface, a claim reporting interface, and connected infrastructure to collect instrumented data associated with cloud-related data/computing service performance The collected data may be used for event classification and liability assignment so that insurance can be meaningfully written and processed.

As described above, insurance products for the physical world are widespread, but are far more limited for data and computing processes or services. As a result, many cloud business models are largely uninsurable, and therefore many businesses that use the cloud are less attractive for investment. Service level agreements (SLAs) with infrastructure providers (e.g., datacenters) may not provide compensation for failure to provide service beyond possibly discounts to a customer's bill. For businesses that use the cloud intending to provide cloud-based services to customers by using infrastructure providers, small performance degradations in the infrastructure (e.g., resource unavailability) may result in significant costs to the business. These potential costs, coupled with the lack of available insurance, means that businesses that use the cloud are often very risky.

Some embodiments described herein enable insurance around things that businesses that use the cloud care about: resource uptime, performance meeting service level agreements, data losses within the cloud, and often transient events like distributed-denial-of-service (DDOS) attacks. Each of these may have a business impact far outweighing the marginal cost of the service lost and may be relatively rare, which is the typical profile of an insurance market. Existing datacenter environments may not provide an insurance adjuster the resources to confidently evaluate a claim. For example, existing datacenter logs may not have sufficient detail and lack the secure chain of possession an insurer would need to evaluate event severity and determine party liability (e.g., whether the datacenter or a customer caused the event).

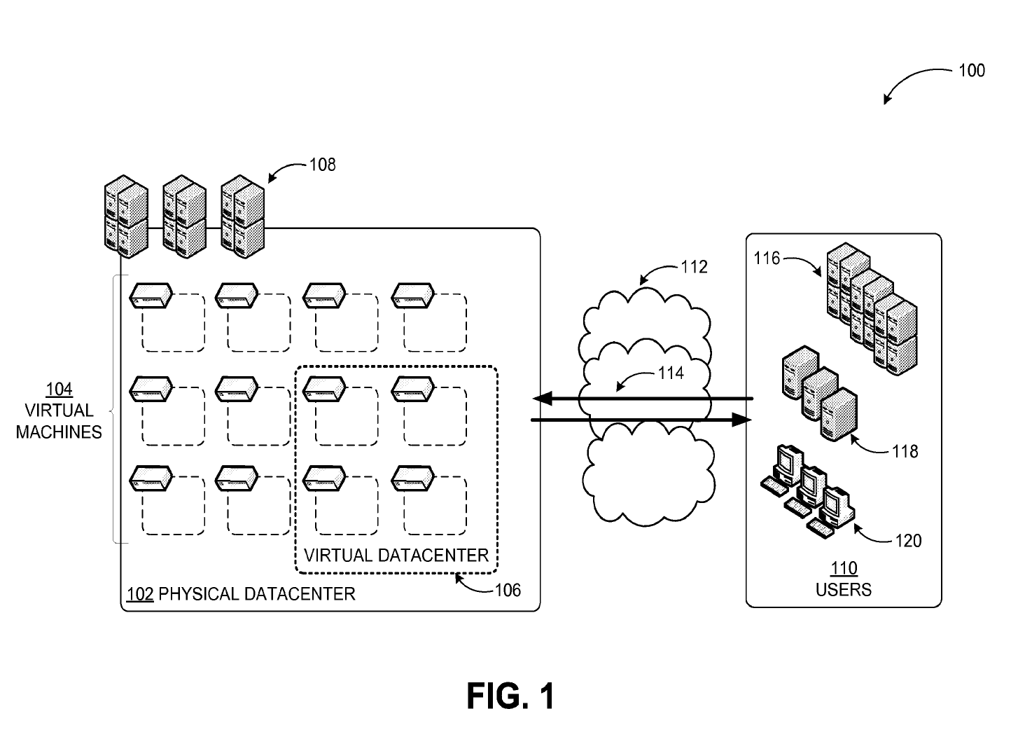

FIG. 1 illustrates an example datacenter, where insurance claim adjustment based on datacenter performance degradations may be provided, arranged in accordance with at least some embodiments described herein.

As shown in a diagram 100, a physical datacenter 102 may include one or more physical servers 108, each of which may be configured to provide one or more virtual machines 104, which in turn may be combined into one or more virtual datacenters 106. The virtual machines 104 and/or the virtual datacenters 106 may be configured to provide cloud-related data/computing services 114 such as various applications, data storage, data processing, or comparable ones to a group of users 110, such as individual users 120 or enterprise customers 116 and 118, via a cloud 112.

As described above, it may be useful to have insurance for certain aspects of the cloud-related data/computing services 114, such as resource uptime, performance meeting specifications, data losses within the cloud, or transient events like distributed-denial-of-service (DDOS) attacks. A lack of useful tools in existing datacenter environments may make it difficult for insurance adjusters to confidently evaluate insurance claims associated with the cloud-related data/computing services 114, and therefore make it difficult for the cloud-related data/computing services 114 to be insured in the first place.

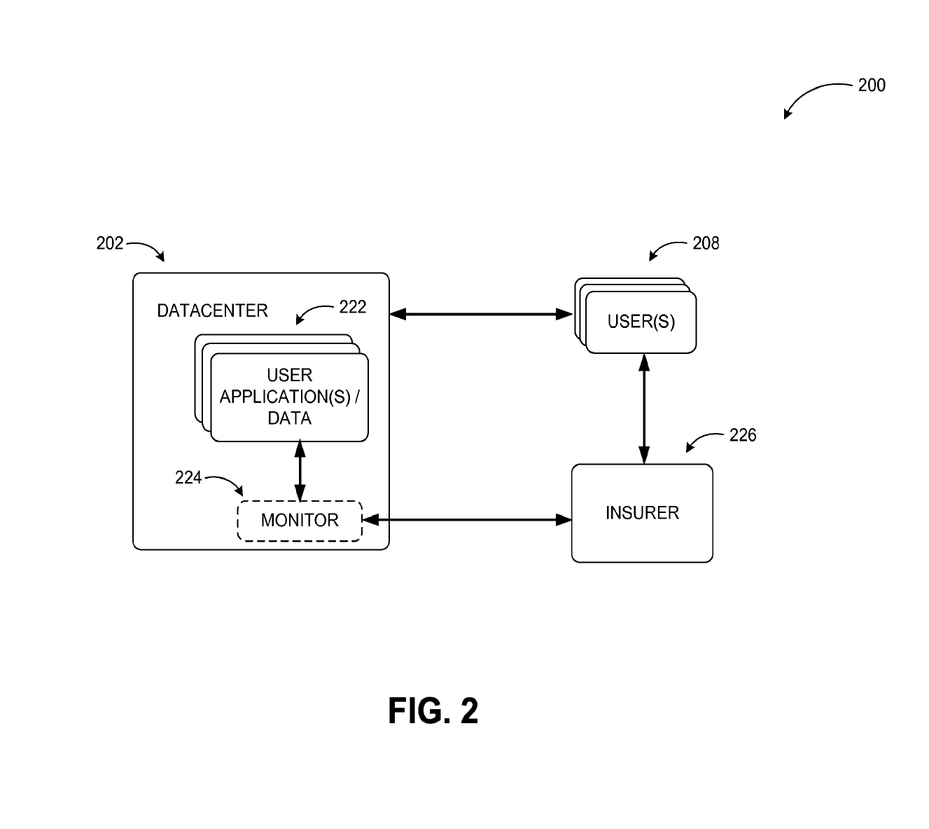

FIG. 2 illustrates major components of a system for providing insurance claim adjustment in cloud-based services based on datacenter performance degradations, arranged in accordance with at least some embodiments described herein.

As shown in a diagram 200, a physical or virtual datacenter 202, similar to the physical datacenter 102 or the virtual datacenter 106 described above in FIG. 1, may provide cloud-related data/computing services (e.g., the cloud-related data/computing services 114 in FIG. 1) to one or more users 208. In some embodiments, the datacenter 202 may host user applications and/or data 222 for providing cloud-related data/computing services.

An insurer 226 may offer insurance to a datacenter or to a customer of a datacenter against various categories of datacenter service problems, such as interruptions of datacenter service to the users 208. The insurer 226 may only want to insure against problems caused by the datacenter 202, not problems attributable to the users 208 such as poorly-programmed applications and/or insufficient purchase of datacenter resources. Therefore, the insurer 226 may establish a monitor 224 at the datacenter 202 to record data at multiple levels before, during, and/or after performance degradations occur in order to determine the party responsible for the problem (e.g., whether a service outage was due to datacenter failure or error on the part of the user). Monitoring may be performed only at virtual machines whose operations are insured, in some examples.

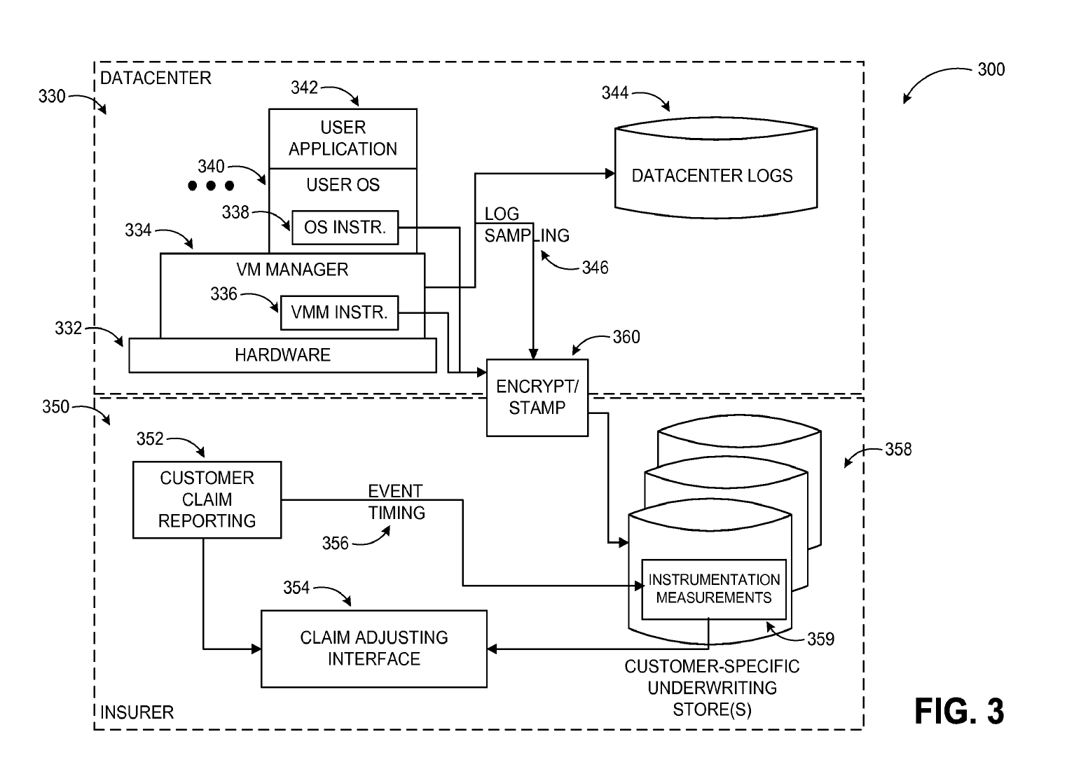

FIG. 3 illustrates an overview of interactions between components of a system 300 for providing insurance claim adjustment based on datacenter performance degradations, arranged in accordance with at least some embodiments described herein.

The system 300 may include a datacenter 330 (similar to the datacenter 202 in FIG. 2) and an insurer 350 (similar to the insurer 226 in FIG. 2). The datacenter 330 may include a virtual machine (VM) manager 334 that manages one or more virtual machines and/or virtual datacenters (e.g., the virtual machines 104 and/or the virtual datacenter 106 in FIG. 1) operating on datacenter hardware 332 (e.g., the physical servers 108 in FIG. 1). The VM manager 330 may also manage one or more user applications 342 operating on one or more user operating systems (OS) 340 such that the user applications 342 and/or the user operating systems 340 share use of the datacenter hardware 332. Data related to the performance and operation of the datacenter 330 may be recorded in a datacenter logs database 344 by, for example, the VM manager 334.

In some circumstances, the performance/operation data recorded in the datacenter logs database 344 may not be sufficient for the insurer 350 to evaluate and adjust insurance claims. For example, the recorded data may have insufficient detail to track the performance of individual virtual machines/applications, be unable to track performance degradations with sufficient granularity, and/or not allow the insurer 350 to adequately determine the party responsible for events of interest (i.e., whether a service issue was caused by the datacenter, a user, or some other party). The insurer 350 may also find it difficult to access the datacenter logs database 344, or may not be able to assure that data in the logs 344 has not been tampered with. Therefore, the insurer 350 may find it desirable to have alternate methods to sample and record datacenter performance data at multiple levels (e.g., at the user application level, the virtual machine/datacenter level, and/or the hardware level).

In some embodiments, the insurer 350 may gather datacenter performance data via one or more of OS instrumentation 338, virtual machine manager (VMM) instrumentation 336, and/or log sampling 346. The OS instrumentation 338 may use software probes and gauges to sense and record states and events as they occur within the user OS 340 and/or the user application 342 by, for example, observing input/output activities and system application programming interface (API) calls. Based on the sensed states and events, the OS instrumentation 338 (or the entity controlling the instrumentation—e.g., the insurer 350 or the datacenter 330) may be able to drill deeper into the user OS/application for more data and/or instruct one or more datacenter systems to automatically reconfigure its operations.

In some embodiments, users may not need to modify their application deployment to include the OS instrumentation 338. For example, modified user operating systems (e.g., user OS 340) including the OS instrumentation 338 (e.g., by including OS library files recompiled to include the OS instrumentation 338) may be provided to users. In some embodiments, a modified OS library file may be able to monitor the OS's command prompt, console, and/or any streaming operations, and may be able to gather performance information using, e.g., a performance data helper API. The recorded state and event data may then be used to track performance parameters, such as rates-of-change of various states and/or multiple values of states, in order to assess system resource health. In some embodiments, the OS instrumentation 338 may be able to identify which resource or programming module (in the user OS or the user application) is responsible for particular performance, down to hardware levels such as hard drive access speeds or network delays.

The VMM instrumentation 336 may behave similarly to the OS instrumentation 338 described above, with the benefit of more direct measurement of virtualization parameters associated with the VM manager 334, virtual machines (e.g., the virtual machines 104), virtual datacenters (e.g., the virtual datacenter 106 in FIG. 1), and/or the hardware 332. However, the VMM instrumentation 336 may provide less access to the user environment (e.g., the user OS 340 and/or the user application 342) than the OS instrumentation 338. Finally, the log sampling 346 may sample some a portion of or all of the data being recorded in the datacenter logs 344, such as data associated with a data store access, network delays, datacenter infrastructure management (DCIM) messages, start/stop times, and/or usage. In some embodiments, the insurer 350 may also gather hardware-related performance parameters directly from instrumentation (not shown) included in the hardware 332. The OS instrumentation 338, the VMM instrumentation 336, and/or any hardware instrumentation at the datacenter 330 may be configured not only to monitor the health of various hardware and software at the datacenter 300, but also to self-evaluate instrumentation performance and fine-tune themselves during runtime to maintain system health and improve performance, without having to apply offline recovery/repair mechanisms.

Data measured by the OS instrumentation 338, the VMM instrumentation 336, the log sampling 346, and/or any hardware instrumentation may be encrypted and/or time/date-stamped (360) according to some examples, either at the datacenter 330 or the insurer 350, and then stored as instrumentation measurements 359 in one or more customer-specific underwriting data stores 358. The instrumentation measurements 359 and/or other stored datacenter performance/operations data may be stored indefinitely, or deleted after a predefined time has passed without a relevant claim being filed. Similarly, the insurer 350 may collect instrumentation measurements and/or datacenter performance/operations data continuously, or only for a predefined time period. For example, the insurer 350 may only collect data during the time an insurance policy covers the datacenter 330 and/or one or more users of the datacenter 330, or may also collect data prior to the time an insurance policy comes into effect or after the insurance policy expires.

When a customer insurance claim associated with a datacenter performance degradation event is filed via a customer claim reporting interface 352 at the insurer 350, event timing data 356 (e.g., the time/date of the datacenter performance degradation event) may be extracted and used to look up the instrumentation measurements 359 stored in the customer-specific underwriting data stores 358 that correspond to the time and date of the performance degradation event. The instrumentation measurements 359 may then be decrypted (if encrypted) and provided to a claims adjusting interface 354 at the insurer 350 and used to evaluate the filed insurance claim.

In some embodiments, the insurer 350 may also analyze the collected datacenter operations data and provide feedback to the management/operators of the datacenter 330 based on the analysis. For example, if the analysis determines that certain user applications, operating systems, and/or hardware components are showing decreased performance, or if certain datacenter best practices are not being followed, the insurer 350 may notify the management/operators of the datacenter 330, who can then take appropriate action. Similarly, the insurer 350 may use the collected datacenter operations data to predict target events across the network or within the datacenter by using various standard time-series techniques for predicting rare events. In some embodiments, the datacenter 330 may also have access to one or more of the instrumentations described above, and may be able to use the various sensed states and events to fine-tune the performance of the hardware 332, the VM manager 334, the user OS 340, and/or the user application 342.

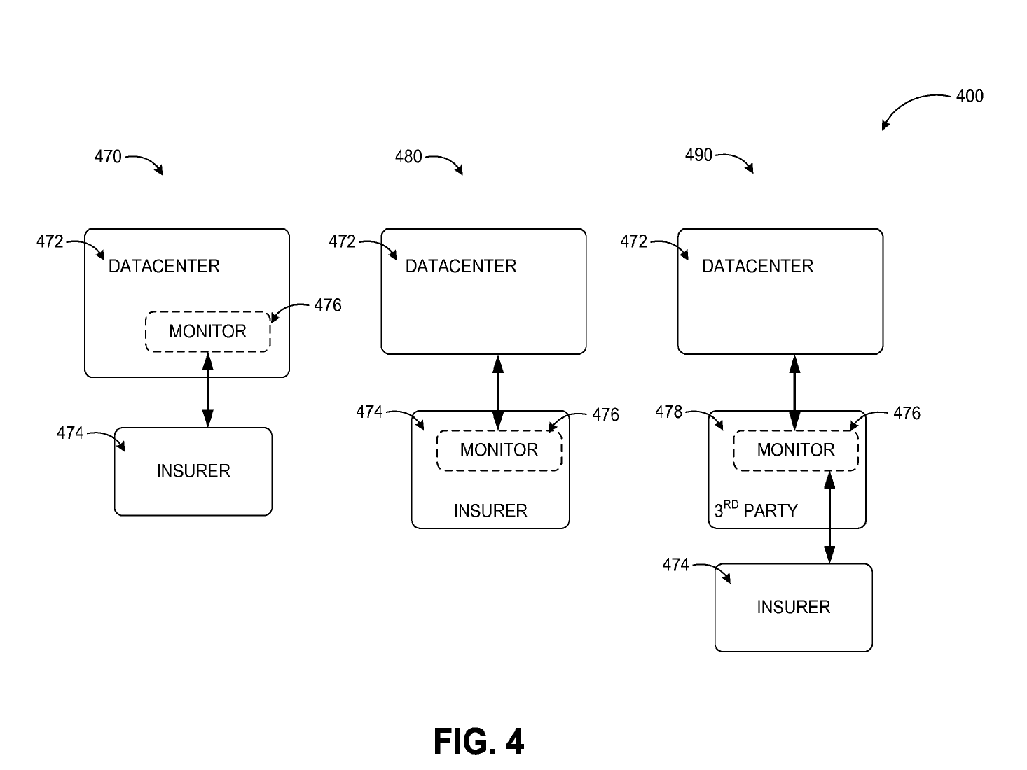

FIG. 4 illustrates example configurations for monitoring datacenter operations in a cloud-based service, arranged in accordance with at least some embodiments described herein. In a configuration 470 shown in a diagram 400, a monitor 476 (similar to the monitor 224 in FIG. 2) for monitoring datacenter operations and performance degradation may be disposed at a datacenter 472, as described above in FIG. 2, and an insurer or insurance underwriter 474 may transmit and receive datacenter performance data to and from the monitor 476. In some embodiments, the monitor 476 may receive performance data from one or more instrumentation (e.g., the OS instrumentation 338 and/or the virtual machine manager instrumentation 336 in FIG. 3) located at the datacenter 472 and/or datacenter log sample data (e.g., the log sampling data 346 in FIG. 3), and transmit the performance and/or datacenter log sample data to the insurer 474.

In another configuration 480 shown in the diagram 400, the monitor 476 may instead be disposed at the insurer 474, and may transmit and receive data from the datacenter 472, such as performance data from one or more instrumentation located at the datacenter 472 and/or datacenter log sample data from the datacenter 472. In yet another configuration 490, the monitor 476 may be disposed at a third party 478 (e.g., an independent monitoring entity), which receives datacenter performance data and/or log samples from the datacenter 472 and transmits the data to the insurer 474. In some embodiments, the third party 478 may be located near or within either the datacenter 472 or the insurer 474, but in other embodiments, the third party 478 may be located remotely to the datacenter 472 and the insurer 474.

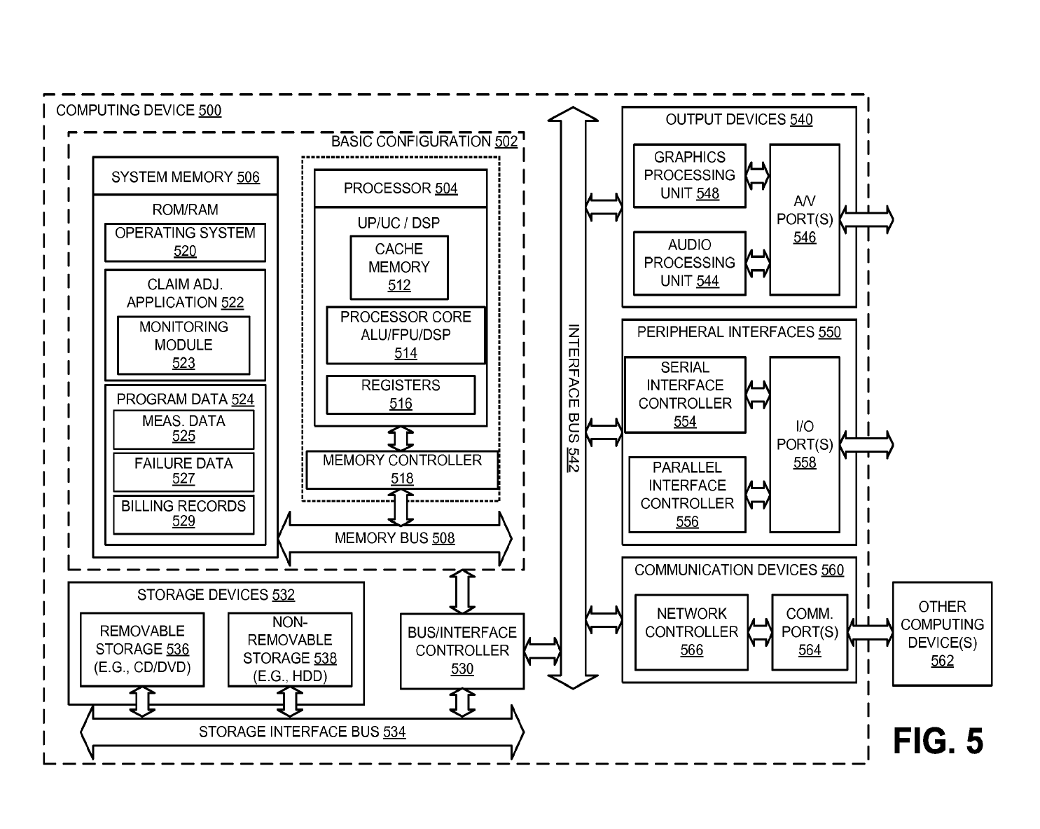

FIG. 5 illustrates a general purpose computing device 500, which may be used to provide insurance claim adjustment based on datacenter performance, arranged in accordance with at least some embodiments described herein. For example, the computing device 500 may be used to enable insurance claim adjustment and/or datacenter performance monitoring as described herein. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof The system memory 506 may include an operating system 520, one or more claim adjustment applications 522, and program data 524. The applications 522 may include a monitoring module 523 for monitoring operations of a datacenter and/or recording performance degradations associated with the datacenter operations as described herein. The program data 524 may include, among other data, measurement data 525, failure data 527, billing records 529, or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 544, and one or more communication devices 566) to the basic configuration 502 via the bus/interface controller 530. Some of the example output devices 542 include a graphics processing unit 548 and an audio processing unit 550, which may be configured to communicate to various external devices such as a display or speakers via one or more AN ports 552. One or more example peripheral interfaces 544 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 566 includes a network controller 560, which may be arranged to facilitate communications with one or more other computing devices 562 over a network communication link via one or more communication ports 564. The one or more other computing devices 562 may include servers at a datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods for providing insurance claim adjustment based on datacenter performance degradations. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other examples, the human interaction can be automated such as by pre-selected criteria that may be machine automated.

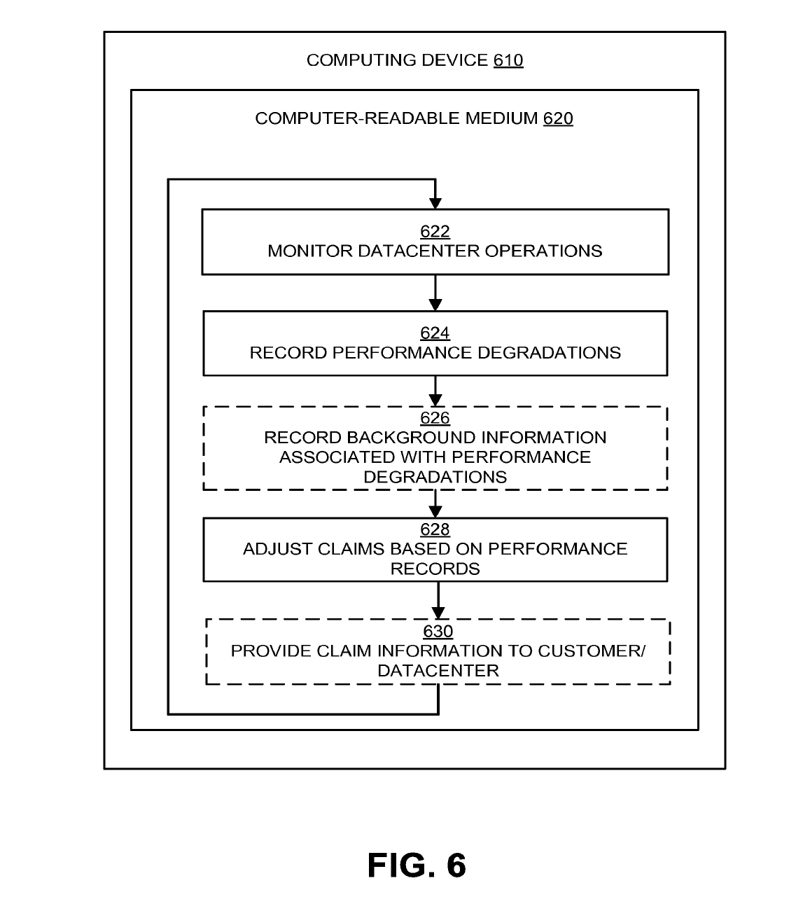

FIG. 6 is a flow diagram illustrating an example method for providing insurance claim adjustment in cloud-based services based on datacenter performance degradations, arranged in accordance with at least some embodiments described herein. Example methods may include one or more operations, functions or actions as illustrated by one or more of blocks 622, 624, 626, 628, and/or 630, and may in some embodiments be performed by a computing device such as the device 500 in FIG. 5. The operations described in the blocks 622-630 may also be stored as computer-executable instructions in a computer-readable medium such as a computer-readable medium 620 of a computing device 610.

An example process for providing insurance claim adjustment in cloud-based services based on datacenter performance degradations may begin with block 622, “MONITOR DATACENTER OPERATIONS”, where instrumentation (e.g., the VMM instrumentation 336 and/or the OS instrumentation 338 in FIG. 3) and/or log sampling (e.g., the log sampling 346 in FIG. 3) may be used to monitor datacenter operations in order to detect performance degradations as described above.

Block 622 may be followed by block 624, “RECORD PERFORMANCE DEGRADATIONS”, where detected datacenter performance degradations (e.g., resource downtime, performance not meeting specifications, data losses, external attacks, etc.) may be recorded by an insurer in one or more customer-specific underwriting data stores (e.g., the customer-specific underwriting stores 359 in FIG. 3). In some embodiments, performance data may be recorded and performance degradation or lack thereof may be determined from the recorded performance data.

In some embodiments, block 624 may be followed by optional block 626, “RECORD BACKGROUND INFORMATION ASSOCIATED WITH PERFORMANCE DEGRADATIONS”, where background information such as data associated with the datacenter (e.g., data associated with the datacenter hardware, virtual machines, data store access information, network delay information, or any other suitable datacenter information) and/or users (e.g., data associated with user operating systems/applications, user billing information, start/stop times, usage information, or any other suitable user information) may be collected (e.g., via instrumentation and/or log sampling as described above) and recorded. The background information may be stored in a customer-specific underwriting data store or in any other suitable data store.

Optional block 626 (or block 624, if optional block 626 is not present) may be followed by block 628, “ADJUST CLAIMS BASED ON PERFORMANCE RECORDS”, where customer claims (e.g., received from the customer claim reporting interface 352 in FIG. 3) against a performance record (e.g., a degradation event) is adjusted (e.g., via the claim adjusting interface 354 in FIG. 3) based on the performance degradation information recorded in block 624 (and, if the optional block 626 is present, recorded background information associated with the performance degradation). For example, the claims may be adjusted to classify the particular type of performance degradation event (e.g., if the event is a resource downtime, a datacenter performance below a service level agreement, an expectation level, a data loss, and/or an external attack) and/or to assign liability.

In some embodiments, block 628 may be followed by optional block 630, “PROVIDE CLAIM INFORMATION TO CUSTOMER/DATACENTER”, where information about the claims adjustment performed in block 628 may be provided to the customer(s) (e.g., the users who filed the claims) and/or the datacenter at which the performance degradation event occurred).

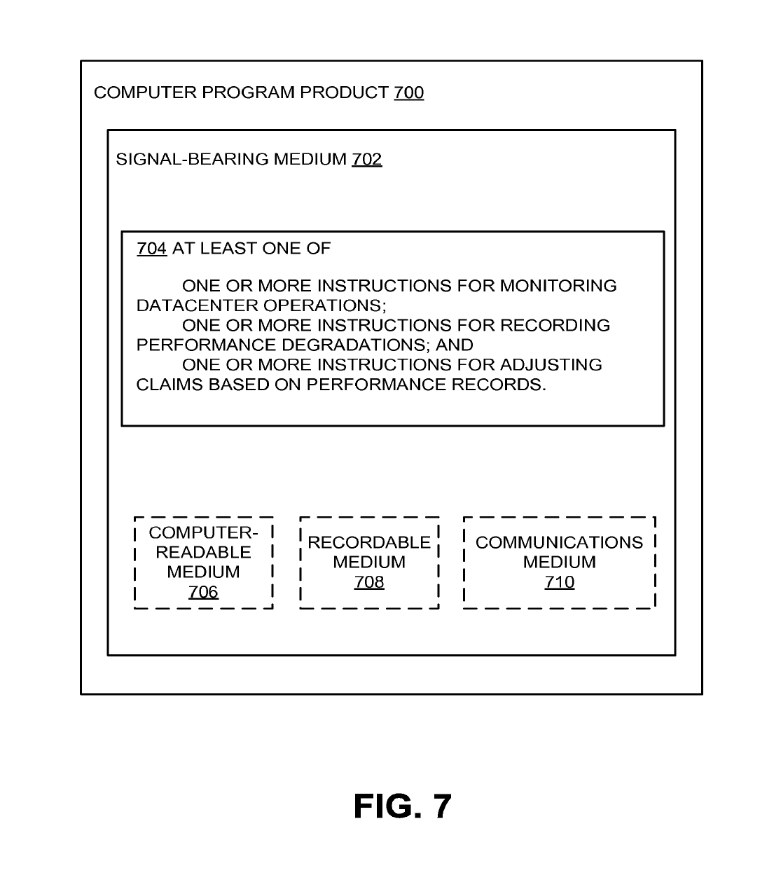

FIG. 7 illustrates a block diagram of an example computer program product arranged in accordance with at least some embodiments described herein.

In some examples, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, the claim adjustment application 522 may undertake one or more of the tasks shown in FIG. 7 in response to the instructions 704 conveyed to the processor 504 by the medium 702 to perform actions associated with providing insurance claim adjustment based on datacenter performance degradations as described herein. Some of those instructions may include, for example, monitoring operations of a datacenter, recording performance degradations associated with the datacenter operations, and/or adjusting insurance claims based on the recorded performance degradations, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, the program product 700 may be conveyed to one or more modules of the processor 704 by an RF signal bearing medium, where the signal bearing medium 702 is conveyed by the wireless communications medium 710 (e.g., a wireless communications medium conforming with the IEEE 802.11 standard).

According to some examples, a method for providing insurance claim adjustment based on datacenter performance degradations may include monitoring operations of a datacenter, recording performance degradations associated with the datacenter operations, and adjusting one or more insurance claims based on the recorded performance degradations.

According to other embodiments, adjusting the one or more insurance claims may include event classification and liability assignment. The performance degradations may include a resource downtime, a datacenter performance below a service level agreement or an expectation level, a data loss, and/or an external attack. The method may further include collecting datacenter operations data prior to a performance degradation event at multiple levels such that a distinction can be made whether the performance degradation is due to a datacenter fault or a customer fault. Recording the performance degradations may include collecting datacenter operations data via deployment operating system instrumentation, virtual machine management instrumentation, hardware instrumentation, and/or datacenter logs.

According to further embodiments, the method may further include collecting the datacenter operations data at a predefined period, selecting the predefined period based on a coverage of an insurance policy, and/or encrypting and time/date coding the collected datacenter operations data. In some embodiments, the method may further include deleting the encrypted datacenter operations data if no claim is filed within a predefined time. The datacenter operations data collected from datacenter logs may include data associated with a data store access, a network delay, a start time, a stop time, and/or a usage. The method may further include analyzing the collected datacenter operations data and providing a feedback to datacenter management.

According to yet other embodiments, the method may further include analyzing states of datacenter systems to determine rates of change of the states and/or multiple values of states to assess a system resource health around a performance degradation event. An insurance associated with datacenter operations may be provided covering a customer of the datacenter or the datacenter. The datacenter operations may be monitored by the datacenter or a third party entity and provided to an insurance underwriter, or the datacenter operations may be monitored by the insurance underwriter.

According to other examples, a server configured to perform insurance claim adjustment based on datacenter performance degradations may include a memory configured to store instructions and a processor configured to execute a monitoring application in conjunction with the stored instructions. The process may be further configured to monitor operations of a datacenter, record performance degradations associated with the datacenter operations, and adjust one or more insurance claims based on the recorded performance degradations.

According to other embodiments, the one or more insurance claims may be adjusted based on event classification and liability assignment. The performance degradations may include a resource downtime, a datacenter performance below a service level agreement or an expectation level, a data loss, and/or an external attack. The processor may be further configured to collect datacenter operations data prior to a performance degradation event at multiple levels such that a distinction can be made whether the performance degradation is due to a datacenter fault or a customer fault. The processor may be configured to record the performance degradations by collecting datacenter operations data via deployment operating system instrumentation, virtual machine management instrumentation, hardware instrumentation, and/or datacenter logs.

According to further embodiments, the processor may be further configured to collect the datacenter operations data at a predefined period, select the predefined period based on a coverage of an insurance policy, and/or encrypt and time/date code the collected datacenter operations data. In some embodiments, the processor may be further configured to delete the datacenter operations data if no claim is filed within a predefined time. The datacenter operations data collected from datacenter logs may include data associated with a data store access, a network delay, a start time, a stop time, and/or a usage. The processor may be further configured to analyze the collected datacenter operations data and provide a feedback to datacenter management.

According to yet other embodiments, the processor may be further configured to analyze states of datacenter systems to determine rates of change of the states and/or multiple values of states to assess a system resource health around a performance degradation event. An insurance associated with datacenter operations may be provided covering a customer of the datacenter or the datacenter. The server may be part of a system managed by the datacenter, a third party entity, and/or an insurance underwriter.

According to further examples, a computer-readable memory device may have instructions stored thereon for providing insurance claim adjustment based on datacenter performance degradations. The instructions may include monitoring operations of a datacenter, recording performance degradations associated with the datacenter operations, and adjusting one or more insurance claims based on the recorded performance degradations.

According to other embodiments, adjusting the one or more insurance claims may include event classification and liability assignment. The performance degradations may include a resource downtime, a datacenter performance below a service level agreement or an expectation level, a data loss, and/or an external attack. The instructions may further include collecting datacenter operations data prior to a performance degradation event at multiple levels such that a distinction can be made whether the performance degradation is due to a datacenter fault or a customer fault. Recording the performance degradations may include collecting datacenter operations data via deployment operating system instrumentation, virtual machine management instrumentation, hardware instrumentation, and/or datacenter logs.

According to further embodiments, the instructions may further include collecting the datacenter operations data at a predefined period, selecting the predefined period based on a coverage of an insurance policy, and/or encrypting and time/date coding the collected datacenter operations data. In some embodiments, the instructions may further include deleting the datacenter operations data if no claim is filed within a predefined time. The datacenter operations data collected from datacenter logs may include data associated with a data store access, a network delay, a start time, a stop time, and/or a usage. The instructions may further include analyzing the collected datacenter operations data and providing a feedback to datacenter management.

According to yet other embodiments, the instructions may further include analyzing states of datacenter systems to determine rates of change of the states and/or multiple values of states to assess a system resource health around a performance degradation event. An insurance associated with datacenter operations may be provided covering a customer of the datacenter or the datacenter. The datacenter operations may be monitored by the datacenter or a third party entity and provided to an insurance underwriter, or the datacenter operations may be monitored by the insurance underwriter.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for providing insurance claim adjustment based on datacenter performance degradations, the method comprising:
monitoring operations of a datacenter;
recording performance degradations associated with the datacenter operations;
adjusting one or more insurance claims based on the recorded performance degradations;
collecting a plurality of datacenter operations data at a predefined period based on coverage of an insurance policy; and
encrypting and time/date coding a collected plurality of datacenter operations data.

2. The method according to claim 1, wherein adjusting the one or more insurance claims includes event classification and liability assignment.

3. The method according to claim 1, wherein the performance degradations include one or more of a resource downtime, a datacenter performance below a service level agreement, an expectation level, a data loss, or an external attack.

4. The method according to claim 1, further comprising collecting the plurality of datacenter operations data prior to a performance degradation event at multiple levels such that a distinction can be made whether the performance degradation is due to a datacenter fault or a customer fault.

5. The method according to claim 1, wherein recording the performance degradations includes collecting the plurality of datacenter operations data via one or more of deployment operating system instrumentation, virtual machine management instrumentation, hardware instrumentation, and/or datacenter logs.

6. (canceled)

7. (canceled)

8. (canceled)

9. (canceled)

10. The method according to claim 5, wherein the plurality of datacenter operations data collected from datacenter logs includes data associated with one or more of a data store access, a network delay, a start time, a stop time, and a usage.

11. The method according to claim 5, further comprising:
analyzing the collected plurality of datacenter operations data; and
providing a feedback to datacenter management.

12. The method according to claim 1, further comprising analyzing states of datacenter systems to determine rates of change of the states and/or multiple values of states to assess a system resource health around a performance degradation event.

13. (canceled)

14. The method according to claim 1, wherein the datacenter operations are monitored by one of: the datacenter and provided to an insurance underwriter, a third party entity and provided to the insurance underwriter, and the insurance underwriter.

15. A server configured to perform insurance claim adjustment based on datacenter performance degradations, the server comprising:
a memory configured to store instructions; and
a processor configured to execute a monitoring application in conjunction with the stored instructions, wherein the processor is configured to:
monitor operations of a datacenter;
record performance degradations associated with the datacenter operations, wherein the performance degradations include one or more of a resource downtime, a datacenter performance below a service level agreement, an expectation level, a data loss, and an external attack;
adjust one or more insurance claims based on one or more of the recorded performance degradations, event classification, and liability assignment; and
encrypt and code a collected plurality of datacenter operations data based on one or more of time and date.

16. (canceled)

17. (canceled)

18. (canceled)

19. The server according to claim 15, wherein the processor is configured to record the performance degradations by collecting datacenter operations data via one or more of deployment operating system instrumentation, virtual machine management instrumentation, hardware instrumentation, and/or datacenter logs.

20. (canceled)

21. The server according to claim 19, wherein the processor is further configured to:
collect the plurality of datacenter operations data at a predefined period; and
select the predefined period based on a coverage of an insurance policy.

22. (canceled)

23. (canceled)

24. The server according to claim 19, wherein the plurality of datacenter operations data collected from datacenter logs includes data associated with one or more of a data store access, a network delay, a start time, a stop time, and a usage.

25. The server according to claim 19, wherein the processor is further configured to:
analyze the collected plurality of datacenter operations data; and
provide a feedback to datacenter management.

26. The server according to claim 15, wherein the processor is further configured to analyze states of datacenter systems to determine rates of change of the states and/or multiple values of states to assess a system resource health around a performance degradation event.

27. (canceled)

28. The server according to claim 15, wherein the server is part of a system managed by one of: the datacenter, a third party entity, and an insurance underwriter.

29. A computer-readable memory device with instructions stored thereon for providing insurance claim adjustment based on datacenter performance degradations, the instructions comprising:
monitoring operations of a datacenter;
recording performance degradations associated with the datacenter operations, wherein a plurality of datacenter operations data are collected from datacenter logs and include data associated with one or more of a data store access, a network delay, a start time, a stop time, and a usage; and
adjusting one or more insurance claims based on the recorded performance degradations.

30. The computer-readable memory device according to claim 29, wherein adjusting the one or more insurance claims includes event classification and liability assignment.

31. The computer-readable memory device according to claim 29, wherein the performance degradations include one or more of a resource downtime, a datacenter performance below a service level agreement, an expectation level, a data loss, or an external attack.

32. (canceled)

33. The computer-readable memory device according to claim 29, wherein recording the performance degradations includes collecting datacenter operations data via one or more of deployment operating system instrumentation, virtual machine management instrumentation, hardware instrumentation, and/or datacenter logs.

34. (canceled)

35. The computer-readable memory device according to claim 33, wherein the instructions further comprise collecting the datacenter operations data at a predefined period and selecting the predefined period based on a coverage of an insurance policy.

36. The computer-readable memory device according to claim 35, wherein the instructions further comprise encrypting and time/date coding the collected datacenter operations data.

37. The computer-readable memory device according to claim 36, wherein the instructions further comprise deleting the datacenter operations data if no claim is filed within a predefined time.

38. (canceled)

39. The computer-readable memory device according to claim 33, wherein the instructions further comprise:
analyzing a collected plurality of datacenter operations data; and
providing a feedback to datacenter management.

40. The computer-readable memory device according to claim 29, wherein the instructions further comprise analyzing states of datacenter systems to determine rates of change of the states and/or multiple values of states to assess a system resource health around a performance degradation event.

41. (canceled)

42. (canceled)
